(19) United States
(12) Patent Application Publication
(10) Pub. No.: US 2023/0389138 A1
(43) Pub. Date: Nov. 30, 2023

(54) POWER SUPPLY DEVICE FOR WARM-KEEPING AND HEATING OF CONTAINER

(71) Applicant: Shenzhen Dingcheng Litian Technology Co., Ltd., Shenzhen (CN)

(72) Inventor: Huimin JIN, Xiangfan (CN)

(73) Assignee: Shenzhen Dingcheng Litian Technology Co., Ltd., Shenzhen (CN)

(21) Appl. No.: 18/314,049

(22) Filed: May 8, 2023

(30) Foreign Application Priority Data
May 24, 2022 (CN) 202210568758.X

(51) Int. Cl. H05B 6/12; A47J 36/24; H01M 50/247; H01M 50/244; H01M 50/284; H01M 10/46; H05B 6/10

(52) U.S. Cl. CPC H05B 6/1209; A47J 36/2483; H01M 50/247; H01M 50/244; H01M 50/284; H01M 10/46; H05B 6/108; H01M 2220/30; H02J 50/005

(57) ABSTRACT

The disclosure provides a power supply device for warm-keeping and heating of a container, including a bottom case and a heating device. The heating device includes a battery and a heating plate. The battery is arranged in the bottom case, and the battery supplies power to the heating plate located on an upper end of the bottom case through a wire. By arranging the heating device and the bottom case and arranging the battery and the heating plate, heating and warm-keeping functions can be realized, so that heating and warm-keeping of the container that needs to be heated can be realized in any place without connection to a power supply, which brings great convenience.

### CROSS-REFERENCE TO RELATED APPLICATIONS

The application claims priority to Chinese patent application No. 202210568758.X, filed on May 24, 2022, the entire contents of which are incorporated herein by reference.

### TECHNICAL FIELD

The disclosure relates to the technical field of heating and warm-keeping equipment in particular to a power supply device for warm-keeping and heating of a container.

### BACKGROUND

In the prior art, water in porcelain mugs or glasses commonly used by users for containing hot water will cool down quickly after being left for a period of time, while hot water in commonly used thermos cannot reach a temperature suitable for drinking quickly. Therefore, many users will usually put a mug on a mug warmer they had to buy, in order to keep the water temperature.

In the prior art. the mug warmer needs to be electrified during use, and a heating function cannot be realized in places where power supply is not available.

An object of the disclosure is to provide a power supply device for warm-keeping and heating of a container, to solve the problems mentioned in the BACKGROUND.

### SUMMARY

In order to achieve the above object, the disclosure provides a power supply device for warm-keeping and heating of a container, including a bottom case and a heating device. The heating device includes a battery and a heating plate. The battery is arranged in the bottom case, and the battery supplies power to the heating plate located on an upper end of the bottom case through a wire.

Preferably, an upper end of an inner cavity of the bottom case is provided with a sealing support and a scaling ring, and the sealing ring mounted on an outer wall of the sealing support is configured to seal a gap between the bottom case and the sealing support.

Preferably, the power supply device further includes a heat insulation pad. The heat insulation pad is arranged between the heating plate and the sealing support.

Preferably, a mounting support is arranged in the bottom case, and the battery is mounted and fixed in the bottom case through the mounting bracket.

Preferably, the power supply device further includes a main board arranged in the bottom case, and a power button and a plurality of indicator lights arranged on a bottom surface of the bottom case. The power button is electrically connected to the main board through a conductive ring.

Preferably, the power supply device further includes a wireless charging device for charging the battery. A magnet cooperating with the wireless charging device is arranged in the bottom case.

Compared with the prior art, the disclosure has the following beneficial elects:

By arranging the heating device and the bottom case and arranging the battery and the heating plate, heating and warm-keeping functions can be realized, so that heating and warm-keeping of the container that needs to be heated can be realized in any place without connection to a power supply, which brim great convenience.

### BRIEF DESCRIPTION OF DRAWINGS

FIG. 1 is a schematic structural view of the disclosure;

FIG. 2 is an exploded view of a heating device and a bottom case of the disclosure; and

FIG. 3 is a schematic structural view of a wireless charging device of the disclosure.

In the figures: 1, heating device; 11, battery; 12, heating plate; 2, bottom case; 21, sealing support; 22, heat insulation pad; 23, mounting support; 24, main board; 25, power button; 26, indicator light; 27, magnet; 211, sealing ring; 3, wireless charging device.

### DETAILED DESCRIPTION OF THE EMBODIMENTS

In order to facilitate the understanding of the disclosure, the disclosure will be described more comprehensively with reference to the related drawings, in which several examples of the disclosure are shown. However, the disclosure may be realized in different forms, and is not limited to the examples described herein. On the contrary, these examples are provided to make the disclosure more thorough and comprehensive.

It should be noted that when an element is referred to as being “fixed to” another element, it may be directly on the another element or there may be an intervening element. When an element is referred to as being “connected to” another element, it may be directly connected to the another element or there may be an intervening element at the same time. As used herein, the terms “vertical”, “horizontal”, “left”, “right” and the like are only for the purpose of illustration.

Unless otherwise defined, all technical and scientific teens used herein have the same meanings as commonly understood by those skilled belonging to the technical field of the disclosure. The terms used in the specification of the disclosure are only for the purpose of describing specific examples and are not intended to limit the disclosure. The term “and/or” used herein includes any and all combinations of one or more related items listed.

The disclosure will be further described in detail below in conjunction with the accompanying drawings.

### Example I

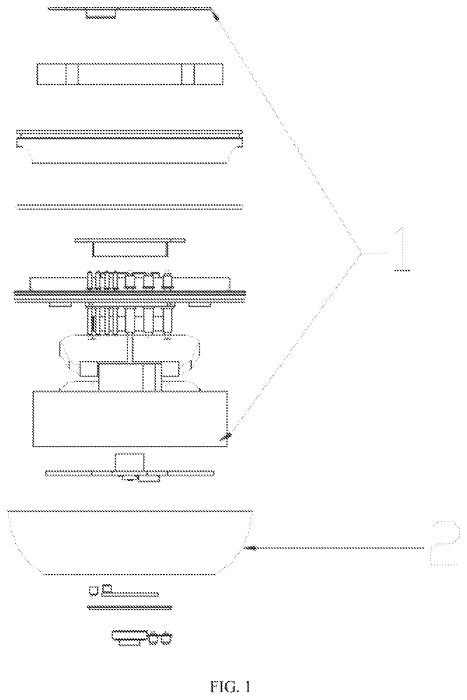

Referring to FIG. 1 to FIG. 3, a power supply device for warm-keeping and heating of a container includes a bottom case 2 and a heating device 1. The heating device 1 includes a battery 11 and a heating plate 12. The battery 11 is arranged in the bottom case 2, and the battery 11 supplies power to the hearing plate 12 located on an upper end of the bottom case 2 through a wire.

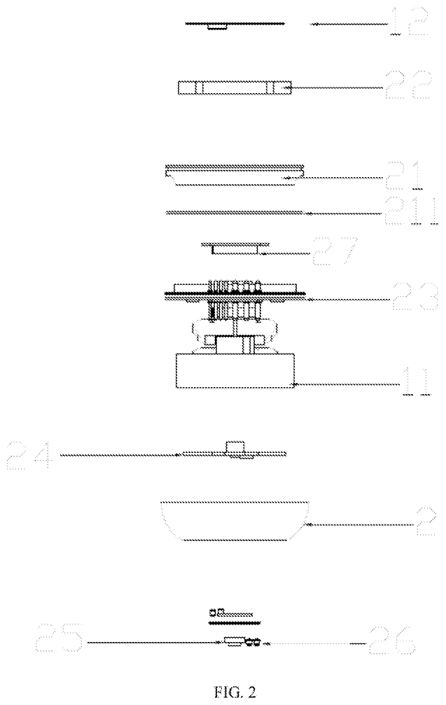

Referring to FIG. 2, an upper end of an inner cavity of the bottom case 2 is provided with a sealing support 21 and a sealing ring 211, and the sealing ring 211 mounted on an outer wall of the sealing support 21 is configured to seal a gap between the bottom case 2 and the sealing support 21. By arranging the sealing support 21 and the sealing ring 211, the gap between the bottom case 2 and the sealing support 21 can be sealed through the sealing ring 211, thereby preventing liquid from entering the inner cavity of the bottom case 2. The power supply device further includes a heat insulation pad 22. The heat insulation pad 22 is arranged between the heating plate 12 and the sealing support 21. By arranging the heat insulation pad 22, heat of the heating plate 12 can be prevented from being transferred into the bottom case 2.A mounting support 23 is arranged in the bottom case 2, and the battery 11 is mounted and fixed in the bottom case 2 through the mounting bracket 23. By arranging the mounting support 23, the battery 11 can be mounted and fixed, thereby avoiding the potential safety hazard caused by the battery 11 being shaken and hit. The power supply device further includes a main board 24 arranged in the bottom case 2, and a power button 25 and a plurality of indicator lights 26 arranged on a bottom surface of the bottom case 2. The power button 25 is electrically connected to the main board 24 through a conductive ring. By arranging the main board 24, the power button 25 and the indicator lights 26, the main board 24 can be triggered through the power button 25 so as to turn on or off the switch between the heating plate 12 and the battery 11, and the indicator lights 26 can show the battery 11 level.

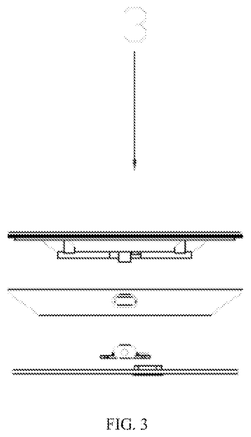

Referring to FIG. 3, the power supply device further includes a wireless charging device 3 for charging the battery 11. A magnet 27 cooperating with the wireless charging device 3 is arranged in the bottom case 2. Through the magnet 27, the bottom case 2 can be connected and fixed to the wireless charging device 3, and the battery 11 can be charged through the wireless device.

The specific operation of Example I of the disclosure is as follows:

The plurality of indicator lights 26 are used to indicate the temperature and the battery level respectively (by the aid of a wireless intelligent module, the main board 24 is remotely controlled through the Internet to set the temperature: three NTC sensors arranged on the heating plate 12 can detect the temperature of the heating plate 12 more intelligently; and when the temperature exceeds the set value, the power of the heating plate 12 is cut off through the main board 24, thereby avoiding heating of the container without water or rapid heating).

### Example II

The battery 11 supplies power to the heating plate 12, so that heating and warm-keeping of the container placed on the heating plate 12 can be realized.

### Example III

The battery 11 is charged magnetically, which is more convenient to use. The output of the adapter of the wireless charging device 3 is 24V 2 A, which is a safe conventional voltage. This further improves the safety and stability of the product, and makes the wireless charging device easier to purchase and replace.

### Example IV

Double heating elements are used in the heating plate 12. Double circuits are intelligently energized to generate heat so as to form a vortex within the range of a heating module, so that the container can be heated uniformly.

The disclosure is described exemplarily by means of above-mentioned description in conjunction with the accompanying drawings. Apparently, the specific implementations of the disclosure are not limited by the above-mentioned manner. Any immaterial improvement carried out by adopting the method concepts and technical solution of the disclosure or the direct application of the concepts and technical solution of the disclosure to other occasions without any improvement shall fall within the scope of protection of the disclosure.

What is claimed is:

1. A power supply device for warm-keeping and heating of a container, comprising a bottom case and a heating device; wherein the heating device comprises a battery and a heating plate, the battery being arranged in the bottom case, and the battery supplying power to the heating plate located on an upper end of the bottom case through a wire.

2. The power supply device for warm-keeping and heating of a container according to claim 1, wherein an upper end of an inner cavity of the bottom case is provided with a sealing support and a sealing ring, and the sealing ring mounted on an outer wall of the sealing support is configured to seal a gap between the bottom case and the sealing support.

3. The power supply device for warm-keeping and heating of a container according to claim 2, further comprising a heat insulation pad, wherein the heat insulation pad is arranged between the heating plate and the sealing support.

4. The power supply device for warm-keeping and heating of a container according to claim 3, wherein a mounting support is arranged in the bottom case, and the battery is mounted and fixed in the bottom case through the mounting bracket.

5. The power supply device for warm-keeping and heating of a container according to claim 4, further comprising a main board arranged in the bottom case, and a power button and a plurality of indicator lights arranged on a bottom surface of the bottom case, wherein the power button is electrically connected to the main board through a conductive ring.

6. The power supply device for warm-keeping and heating of a container according to claim 5, further comprising a wireless charging device for charging the battery, wherein a magnet cooperating with the wireless charging device is arranged in the bottom case.
